(19) United States
(12) Patent Application Publication
(10) Pub. No.: US 2009/0315847 A1
(43) Pub. Date: Dec. 24, 2009

(54) INPUT APPARATUS HAVING TOUCH PANEL OPERATION ACCEPTING METHOD, AND OPERATION ACCEPTING PROGRAM EMBODIED ON COMPUTER READABLE MEDIUM

(75) Inventor: Masato Fujii, Nagaokakyo-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/480,843

(22) Filed: Jun. 9, 2009

(30) Foreign Application Priority Data
Jun. 20, 2008 (JP) 2008-161121

(51) Int. Cl. G06F 3/041; G06F 3/048

(52) U.S. Cl. 345/173; 715/764

(57) ABSTRACT

In order to facilitate an operation, an MFP includes a touch panel which has an operation-accepting surface and detects a position on the operating-accepting surface designated by a user, an operating object discriminating portion to discriminate types of operating objects based on the number of positions on the operation-accepting surface simultaneously detected by the touch panel, an operation system determining portion to determine one of a plurality of predetermined operation systems based on the discriminated type of the operating object, and an operation accepting portion to accept an operation in accordance with the determined one of the plurality of operation systems based on the position detected by the touch panel.

This application is based on Japanese Patent Application No. 2008-161121 filed with Japan Patent Office on Jun. 20, 2008, the entire content of which is hereby incorporated by reference.

### BACKGROUND OF THE INVENTION

1. Field of the Invention

The present invention relates to an input apparatus, an operation accepting method, and an operation accepting program embodied on a computer readable medium. More particularly, the present invention relates to an input apparatus provided with a touch panel, an operation accepting method which is executed in the input apparatus, and an operation accepting program embodied on a computer readable medium which causes a computer to execute the operation accepting method.

2. Description of the Related Art

Recently, image forming apparatuses, represented by multi function peripherals (MFPs), have increased in variety of their functions and, hence, increased in complexity of their operations. For simplification of the operations, some image forming apparatuses are provided with a touch panel, and techniques for facilitating input operations using the touch panel have been developed. For example, Japanese Patent Laid-Open No. 5-046308 discloses a panel input apparatus having a panel surface which detects touch operations by an operator's fingers. The apparatus includes detecting means and setting means, wherein in response to touch operations made by a plurality of fingers onto the panel surface in a setting mode for setting intervals between touch operation positions, the detecting means detects each interval between the operation positions touched by the neighboring fingers, and the setting means sets the intervals between the touch operation positions by the plurality of fingers based on the detected intervals between the neighboring operation positions.

For the input operation using a touch panel, a user may directly touch the panel with a finger, or use a stylus pen to touch the panel. In the case where the stylus pen is used, the contact area between the stylus pen and the touch panel is smaller than the contact area between the finger and the touch panel, and thus, the input operation using the stylus pen is suitable for a delicate or precise input operation. The use of the stylus pen enables an input of an instruction using an operation system in which the instruction is input with a drag-and-drop operation and the like, besides an operation system in which the instruction is input with a button operation. While the conventional input apparatus allows setting of the key size in accordance with the human finger size, it cannot be adapted to the input method using the operation system suited to the stylus pen.

### SUMMARY OF THE INVENTION

The present invention has been accomplished in view of the foregoing problems, and an object of the present invention is to provide an input apparatus which facilitates an operation.

Another object of the present invention is to provide an operation accepting method which facilitates an operation.

A further object of the present invention is to provide an operation accepting program embodied on a computer readable medium which facilitates an operation.

In order to achieve the above-described objects, according to an aspect of the present invention, an input apparatus includes: a pointing device having an operation-accepting surface and detecting a position on the operation-accepting surface designated by a user; an operating object discriminating portion to discriminate types of operating objects based on the number of positions on the operation-accepting surface simultaneously detected by the pointing device; an operation system determining portion to determine one of a plurality of predetermined operation systems based on the discriminated type of the operating object; and an operation accepting portion to accept an operation in accordance with the determined one of the plurality of operation systems based on the position detected by the pointing device.

According to another aspect of the present invention, an operation accepting method is carried out in an input apparatus provided with a pointing device, which method includes the steps of: detecting a position on an operation-accepting surface of the pointing device designated by a user; discriminating types of operating objects based on the number of positions simultaneously detected in the detecting step; determining one of a plurality of predetermined operation systems based on the discriminated type of the operating object; and accepting an operation in accordance with the determined one of the plurality of operation systems based on the position detected in the detecting step.

According to a further aspect of the present invention, an operation accepting program embodied on a computer readable medium is executed by a computer provided with a pointing device, wherein the program causes the computer to perform the steps of: detecting a position on an operation-accepting surface of the pointing device designated by a user; discriminating types of operating objects based on the number of positions simultaneously detected in the detecting step; determining one of a plurality of predetermined operation systems based on the discriminated type of the operating object; and accepting an operation in accordance with the determined one of the plurality of operation systems based on the position detected in the detecting step.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an MFP according to an embodiment of the present invention.

FIG. 2 is a block diagram showing by way of example the hardware configuration of the MFP.

FIG. 3 is a plan view showing an example of an operation panel.

FIG. 4 is a functional block diagram showing by way of example the functions of a CPU included in the MFP, together with information stored in an HDD.

FIG. 5 shows an example of a login screen.

FIG. 6 shows an example of a data copy screen, which is a screen for a first operation system.

FIG. 7 shows an example of a data operation screen, which is a screen for a second operation system.

FIG. 8 is a flowchart illustrating an example of the flow of operation accepting processing.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

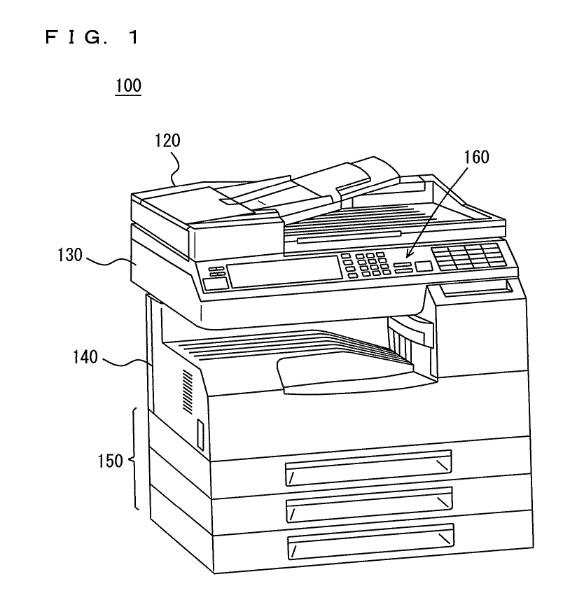

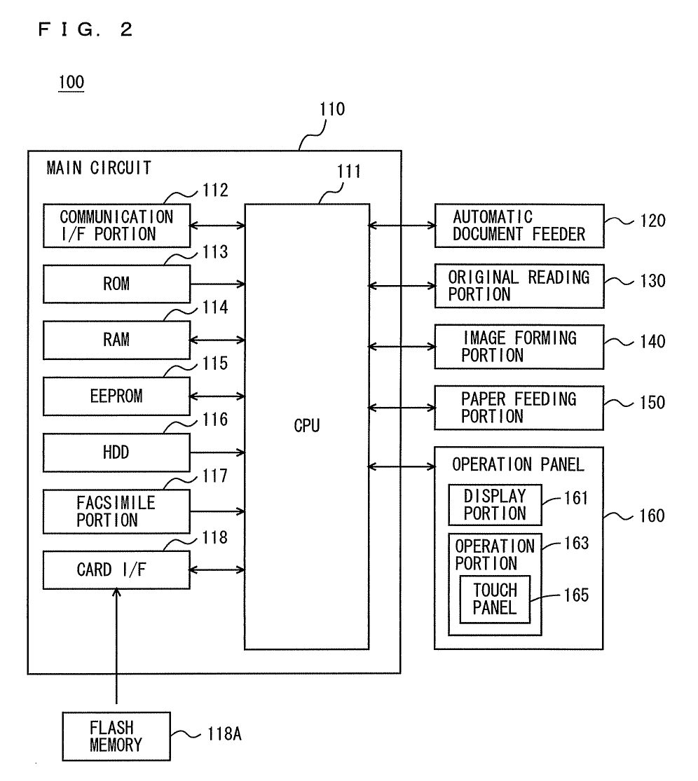

FIG. 1 is a perspective view of an MFP according to an embodiment of the present invention, and FIG. 2 is a block diagram showing by way of example the hardware configuration of the MFP. Referring to FIGS. 1 and 2, an MFP 100 includes: a main circuit 110; an original reading portion 130 which reads an image of an original formed on the original; an automatic document feeder 120 which carries an original into original reading portion 130; an image forming portion 140 which forms a still image on a sheet of paper or the like, the still image being an image of an original formed on the original that is read by and output from original reading portion 130; a paper feeding portion 150 which supplies sheets of paper to image forming portion 140; and an operation panel 160 serving as a user interface.

Main circuit 110 includes a central processing unit (CPU) 111, a communication interface (I/F) portion 112, a read only memory (ROM) 113, a random access memory (RAM) 114, an electrically erasable and programmable ROM (EEPROM) 115, a hard disk drive (HDD) 116 as a mass storage, a facsimile portion 117, and a card interface (I/F) 118 mounted with a flash memory 118A. CPU 111 is connected with automatic document feeder 120, original reading portion 130, image forming portion 140, paper feeding portion 150, and operation panel 160, and is responsible for overall control of MFP 100.

ROM 113 stores a program executed by CPU 111 or data necessary for execution of the program. RAM 114 is used as a work area when CPU 111 executes a program. Further, RAM 114 temporarily stores still images continuously transmitted from original reading portion 130.

Operation panel 160, which is provided on an upper surface of MFP 100, includes a display portion 161 and an operation portion 163. Display portion 161 is a display such as a liquid crystal display (LCD) or an organic electro-luminescence display (organic ELD), and displays an operation screen which includes an instruction menu for the user, information about acquired image data, and others. Operation portion 163, which is provided with a plurality of keys, accepts input data such as instructions, characters, and numerical characters, according to the key operations by the user. Operation portion 163 further includes a touch panel 165 provided on display portion 161.

Communication I/F portion 112 is an interface for connecting MFP 100 to a network. CPU 111 communicates via communication I/F portion 112 with another computer connected to the network, for transmission/reception of data. Further, communication I/F portion 112 is capable of communicating with another computer connected to the Internet via the network.

Facsimile portion 117 is connected to public switched telephone networks (PSTN), and transmits facsimile data to or receives facsimile data from the PSTN. Facsimile portion 117 stores the received facsimile data in HDD 116, or outputs it to image forming portion 140. Image forming portion 140 prints the facsimile data received by facsimile portion 117 on a sheet of paper. Further, facsimile portion 117 converts the data stored in HDD 116 to facsimile data, and transmits it to a facsimile machine connected to the PSTN. Card I/F 118 is mounted with flash memory 118A. CPU 111 is capable of accessing flash memory 118A via card I/F 118. CPU 111 loads a program, which is recorded on flash memory 118A mounted to card I/F 118, into RAM 114 for execution. It is noted that the program executed by CPU 111 is not restricted to the program recorded on flash memory 118A. CPU 111 may load the program stored in HDD 116 into RAM 114 for execution. In this case, another computer connected to the network may rewrite the program stored in HDD 116 of MFP 100, or may additionally write a new program therein. Further, MFP 100 may download a program from another computer connected to the network, and store the program in HDD 116. As used herein, the “program” includes, not only the program which CPU 111 can execute directly, but also a source program, a compressed program, an encrypted program, and others.

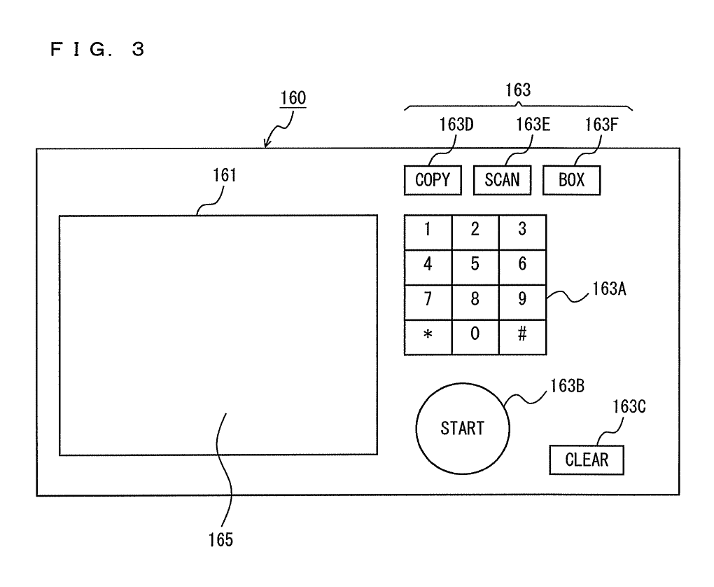

FIG. 3 is a plan view showing an example of the operation panel. Referring to FIG. 3, operation panel 160 includes display portion 161 and operation portion 163. Operation portion 163 includes: a ten-key pad 163A; a start key 163B; a clear key 163C for canceling the input content; a copy key 163D for causing MFP 100 to enter a copy mode for execution of a copying process; a scan key 163E for causing MFP 100 to enter a scan mode for execution of a scanning process; a BOX key 163F for causing MFP 100 to enter a data transmission mode for execution of a data transmitting process; and touch panel 165 formed of a transparent member, which is mounted on display portion 161. The touch panel is a pointing device, with an operation-accepting surface for accepting operations. Touch panel 165 may be a resistive film-type touch panel or a surface acoustic wave-type touch panel, although it is not particularly restricted thereto.

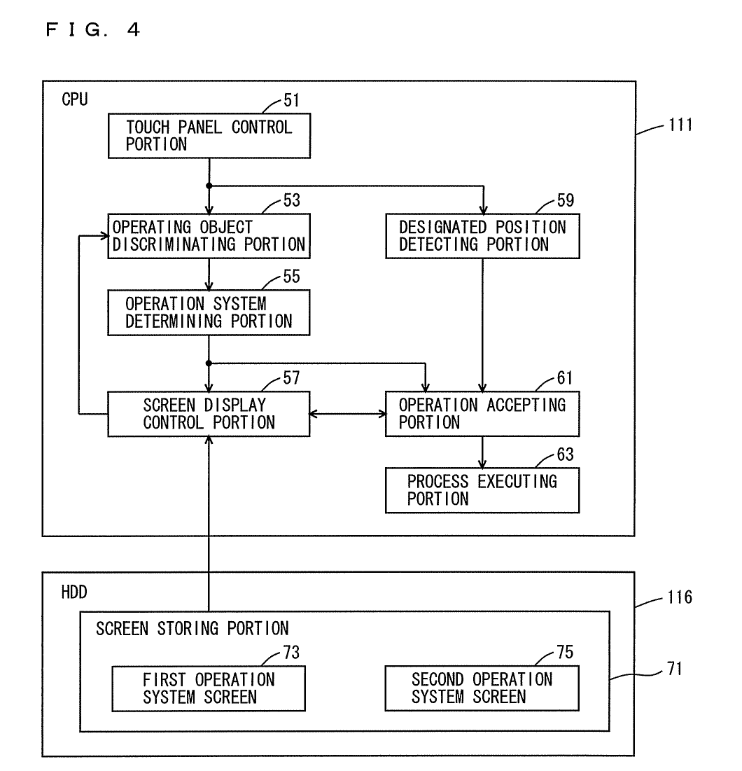

FIG. 4 is a functional block diagram schematically showing the functions of the CPU included in the MFP, together with information stored in the HDD. Referring to FIG. 4, CPU 111 included in MFP 100 includes: a touch panel control portion 51 to control touch panel 165; an operating object discriminating portion 53 to discriminate operating objects which have touched touch panel 165; an operation system determining portion 55 to determine an operation system; a screen display control portion 57 to control display portion 161; a designated position detecting portion 59 to detect a designated position on touch panel 165; an operation accepting portion 61 to accept an operation; and a process executing portion 63 to execute a process according to an accepted operation.

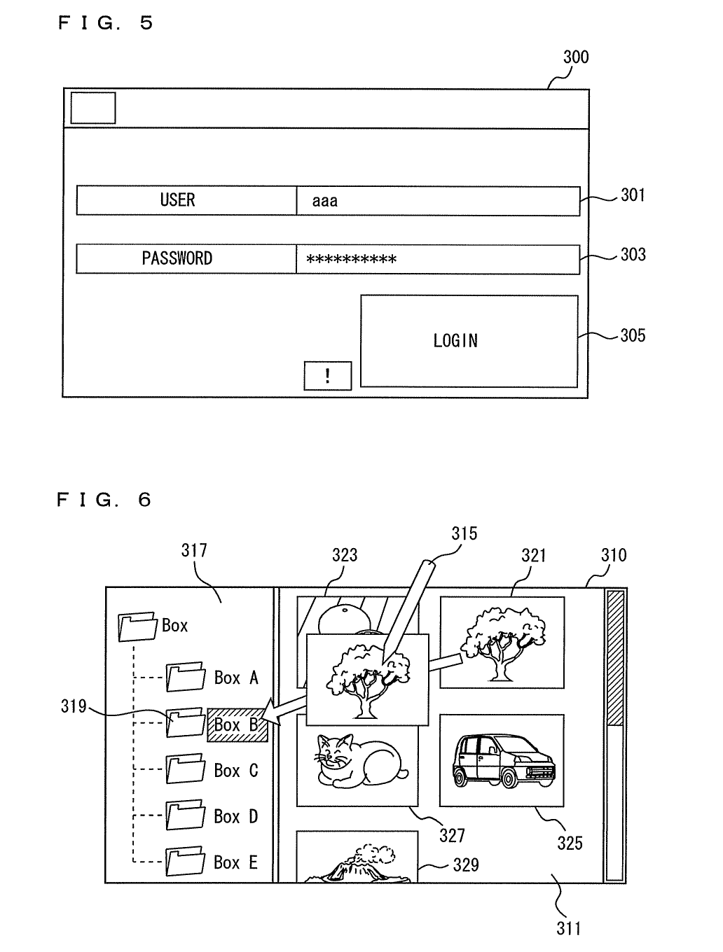

Touch panel control portion 51 controls touch panel 165. Touch panel 165 detects a position designated by a finger or a stylus pen, and outputs the coordinates of the detected position to CPU 111. The area of touch panel 165 contacted by the finger is larger than the area of touch panel 165 contacted by the stylus pen. Thus, the number of positions simultaneously detected by touch panel 165 when it is touched by the finger is greater than the number of positions simultaneously detected by touch panel 165 when it is touched by the stylus pen. Touch panel control portion 51 outputs the coordinates of the position input from touch panel 165 to operating object discriminating portion 53 and designated position detecting portion 59. In the case where the coordinates of a plurality of positions are input from touch panel 165, touch panel control portion 51 outputs the coordinates of all the positions to operating object discriminating portion 53 and designated position detecting portion 59. Screen display control portion 57 controls display portion 161 to display a screen on display portion 161. In the state where a user has not logged in, screen display control portion 57 displays a login screen on display portion 161. FIG. 5 shows an example of the login screen. Referring to FIG. 5, a login screen 300 includes a field 301 in which user identification information for identifying a user is input, a field 303 in which a password is input, and a login button 305 having the characters “login” displayed thereon. When a user inputs user identification information in field 301 and a password in field 303 and designates login button 305 with the finger or the stylus pen, the user identification information and the password input to respective fields 301 and 303 are accepted by operation accepting portion 61, which will be described later, and further, an authentication process is carried out by process executing portion 63, which will also be described later, based on the accepted user identification information and password.

Returning to FIG. 4, operating object discriminating portion 53 discriminates the operating objects which have touched touch panel 165, based on the coordinates of one or more positions input from touch panel control portion 51 when login button 305 in login screen 300 displayed by screen display control portion 57 is designated. Specifically, in the case where the number of coordinates of the positions input from touch panel control portion 51 is greater than a predetermined threshold value, operating object discriminating portion 53 determines that the operating object is a human finger, whereas if the number of coordinates is not greater than the predetermined threshold value, operating object discriminating portion 53 determines that the operating object is a stylus pen. Operating object discriminating portion 53 outputs the result of discrimination to operation system determining portion 55.

Operating object discriminating portion 53 discriminates the operating object in response to the event that login button 305 included in login screen 300 displayed by screen display control portion 57 has been designated. This can restrict the coordinates of positions input from touch panel control portion 51 to those falling within the area of login button 305, and hence, can decrease the number of times of calculations required for discriminating the operating object. This results in an increased processing speed for discrimination. Furthermore, it is unnecessary for the user to perform any special operations for selecting an operation system.

Operation system determining portion 55 determines an operation system based on the result of discrimination input from operating object discriminating portion 53. In this example, the operation system is determined to be a first operation system when the result of discrimination input indicates that the operating object is a stylus pen, whereas it is determined to be a second operation system when the result of discrimination input indicates that the operating object is a human finger. Operation system determining portion 55 outputs the result of determination to screen display control portion 57 and operation accepting portion 61. When the operation system determined by operation system determining portion 55 is received therefrom, screen display control portion 57 displays on display portion 161 an operation screen corresponding to the operation system received. Screen display control portion 57 displays the operation screen from when it receives the operation system until the user logs out. HDD 116 includes a screen storing portion 71. Screen storing portion 71 stores in advance a first operation system screen 73 which is an operation screen corresponding to the first operation system and a second operation system screen 75 which is an operation screen corresponding to the second operation system. In the case where the result of determination indicating the first operation system is input from operation system determining portion 55, screen display control portion 57 reads and displays first operation system screen 73 on display portion 161, whereas in the case where the result of determination indicating the second operation system is input from operation system determining portion 55, screen display control portion 57 reads and displays second operation system screen 75 on display portion 161. Screen display control portion 57 outputs screen information for identifying first operation system screen 73 or second operation system screen 75 displayed on display portion 161, to operation accepting portion 61 and process executing portion 63.

Designated position detecting portion 59 detects a designated position on touch panel 165, based on the coordinates of one or more positions input from touch panel control portion 51. Specifically, in the case where the coordinates of one position are input from touch panel control portion 51, designated position detecting portion 59 detects the position as the designated position. In the case where the coordinates of two or more positions are input from touch panel control portion 51, designated position detecting portion 59 detects a middle point of the plurality of positions as the designated position. Designated position detecting portion 59 outputs the coordinates of the detected, designated position, to operation accepting portion 61.

Operation accepting portion 61 receives the screen information from screen display control portion 57 and the designated position from designated position detecting portion 59. Operation accepting portion 61 specifies an operation based on the operation screen specified by the screen information and the designated position. For example, in the case where the screen information for identifying login screen 300 is input, operation accepting portion 61 specifies an authentication process predetermined corresponding to login screen 300, and specifies an operation for the specified process. More specifically, it specifies an input operation of user identification information, an input operation of a password, and an input operation of a login instruction. In the case where the coordinates of the designated position fall within field 301 in login screen 300, operation accepting portion 61 displays a list of user identification information on display portion 161, and thereafter, accepts the user identification information which is displayed at the coordinates of the designated position input from designated position detecting portion 59. Further, in the case where the coordinates of the designated position fall within field 303 in login screen 300, operation accepting portion 61 accepts a password input via ten-key pad 163A. Furthermore, in the case where the coordinates of the designated position fall within the area of login button 305 in login screen 300, operation accepting portion 61 accepts the login instruction. Upon receipt of the login instruction, operation accepting portion 61 outputs the user identification information, the password, and an execution command to execute the authentication process, to process executing portion 63.

It may be configured such that, when operation accepting portion 61 accepts a login instruction, it outputs a signal indicating that the login instruction has been accepted to operating object discriminating portion 53, to notify operating object discriminating portion 53 of the time to discriminate the operating object.

Process executing portion 63 executes a process in accordance with an instruction input from operation accepting portion 61. For example, in the case where the user identification information, the password, and the execution command to execute the authentication process are input from operation accepting portion 61, process executing portion 63 uses the user identification information and the password input from operation accepting portion 61 to execute the authentication process.

Further, operation accepting portion 61 specifies different operations according to whether the screen specified by the screen information is first operation system screen 73 or second operation system screen 75. Hereinafter, specific examples of the first and second operation systems will be described.

FIG. 6 shows an example of a data copy screen, which is a screen for a first operation system. Referring to FIG. 6, a data copy screen 310, corresponding to first operation system screen 73, includes: an area 317 in which a plurality of box names for respectively identifying a plurality of storage areas included in HDD 116 is displayed; and an area 311 in which thumbnails 321, 323, 325, 327, and 329 are displayed, which are reduced-size versions of respective images for a plurality of image data items stored in the storage area designated in area 317. In data copy screen 310 which is first operation system screen 73, the image data included in a certain storage area can be copied to another storage area by a drag-and-drop operation. FIG. 6 shows the operation of copying the image data corresponding to thumbnail 321 into the storage area having the box name “BOX B”. Specifically, thumbnail 321 is firstly designated with the stylus pen 315. As stylus pen 315 is moved while it is kept in contact with touch panel 165 to the position in area 317 where the box name “BOX B” is displayed, thumbnail 321 is dragged to that position. When stylus pen 315 is released from touch panel 165 at the position, thumbnail 321 that has been dragged is dropped into “BOX B” 319. This operation allows the image data corresponding to thumbnail 321 to be copied into the storage area with the box name “BOX B”. Herein, the operation to designate the image data as a copy source is referred to as a “drag operation”, and the operation to designate the storage area in HDD 116 as a destination of the copied data is referred to as a “drop operation”.

Returning to FIG. 4, in the case where the screen information for identifying data copy screen 310 corresponding to first operation system screen 73 is input to operation accepting portion 61, operation accepting portion 61 specifies the copying process which is predetermined corresponding to data copy screen 310 or first operation system screen 73, and specifies the drag-and-drop operation for that specified process. Specifically, it specifies the drag operation to designate the image data as the copy source, and the drop operation to designate a storage area in HDD 116 as the destination of the copied data. For example, in the case where the coordinates of the designated position fall within the area of thumbnail 321 in data copy screen 310 or first operation system screen 73, operation accepting portion 61 determines that the drag operation to designate the image data as the copy source has been accepted, and accepts the image data corresponding to thumbnail 321 as the copy source. After the coordinates of the designated positions are changed continuously, there comes the time when the coordinates of the designated position are no longer accepted. If the coordinates of the designated position lastly accepted fall on the box name “BOX B” 319 in data copy screen 310 or first operation system screen 73, operation accepting portion 61 determines that the drop operation has been accepted, and accepts the storage area in HDD 116 which is identified by the box name “BOX B” 319 as the destination of the copied data. That is, the first operation system corresponds to the operation with which the coordinates of the designated positions change continuously, or in other words, it corresponds to the operation that is specified with a plurality of designated positions.

Operation accepting portion 61 outputs to process executing portion 63 the file name of the image data corresponding to thumbnail 321 which is accepted as a copy source, the box name of the storage area in HDD 116 which is accepted as a destination of the copied data, and a copy command. Process executing portion 63, based on the file name and the box name input from operation accepting portion 61, copies the image data specified by the file name to the storage area identified by the box name.

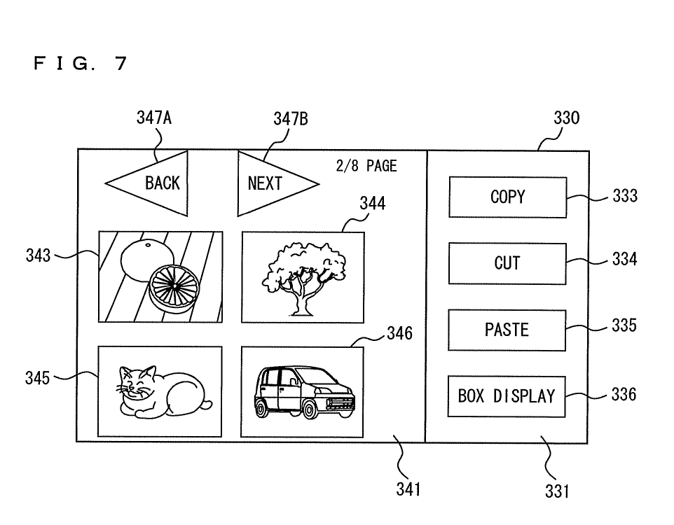

FIG. 7 shows an example of a data operation screen, which is a screen for a second operation system. Referring to FIG. 7, a data operation screen 330, corresponding to second operation system screen 75, includes an area 331 in which command buttons 333 to 336 are displayed, and an area 341 in which thumbnails 343 to 346 are displayed, which are reduced-size versions of respective images for a plurality of image data items stored in one of the plurality of storage areas included in HDD 116. Command button 333 is associated with a command to set selected data as data to be copied; command button 334 is associated with a command to set the selected data as data to be moved; command button 335 is associated with a command to store the data selected as the data to be copied or the data to be moved in a selected storage area; and command button 336 is associated with a command to switch the display to a screen for selecting one of a plurality of storage areas included in HDD 116.

Data operation screen 330, or second operation system screen 75, allows an input of an operation of processing the image data included in a certain box, with an operation of selecting a process target and an operation of specifying a process content. Here, the operation of selecting the image data corresponding to thumbnail 343 as the data to be copied will be described. For example, the image data corresponding to thumbnail 343 is firstly selected with the operation of designating thumbnail 343 with a finger. Next, with the operation of designating command button 333 with a finger, the process content of selecting it as the data to be copied is specified. With these operations, the image data corresponding to thumbnail 343 is selected as the data to be copied. Returning to FIG. 4, in the case where the screen information for identifying data operation screen 330 which is second operation system screen 75 is input to operation accepting portion 61, operation accepting portion 61 specifies a data selecting operation and a process specifying operation that are predetermined corresponding to data operation screen 330 or second operation system screen 75. For example, in the case where the coordinates of the designated position fall within the area of thumbnail 343 in data operation screen 330 which is second operation system screen 75, operation accepting portion 61 determines that the data selecting operation designating the image data as a process target has been accepted, and accepts the image data corresponding to thumbnail 343 as the image data as the process target. Then, in the case where the coordinates of the designated position fall within one of command buttons 333 to 336 in data operation screen 330 which is second operation system screen 75, operation accepting portion 61 determines that the process specifying operation has been accepted, and accepts the command assigned to the one of command buttons 333 to 336 corresponding to the designated position. Operation accepting portion 61 outputs to process executing portion 63 the file name of the image data corresponding to thumbnail 343 which is accepted as the process target, and the accepted command. Process executing portion 63, based on the file name and the command input from operation accepting portion 61, executes the process specified by the command on the image data specified by the file name.

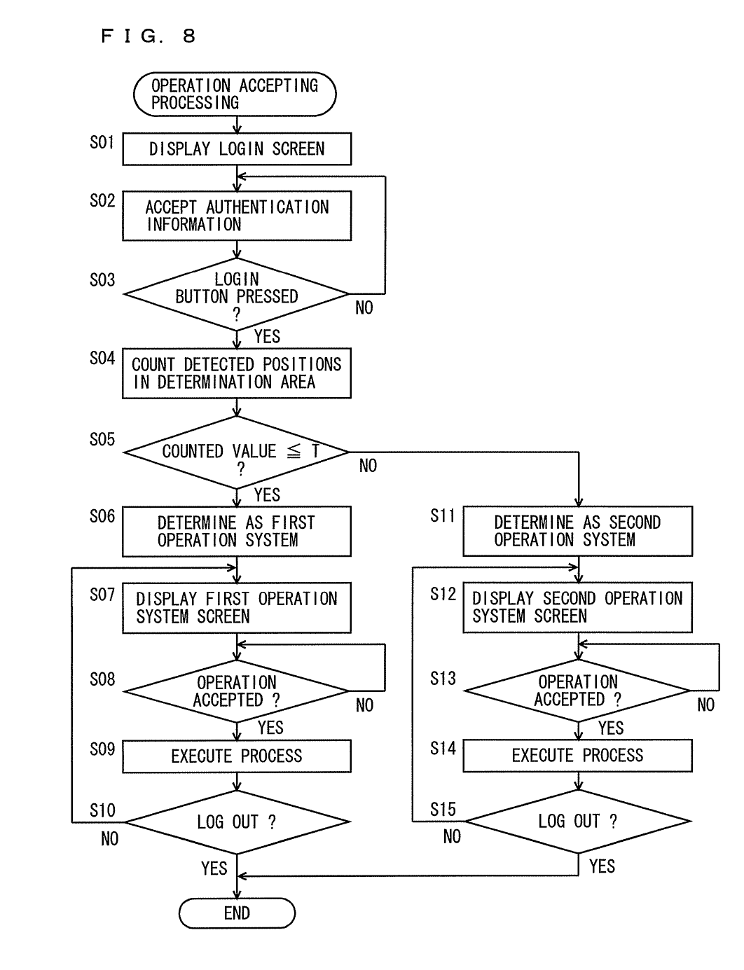

FIG. 8 is a flowchart illustrating an example of the flow of operation accepting processing. The operation accepting processing is carried out by CPU 111 as CPU 111 executes an operation accepting program. Referring to FIG. 8, CPU 111 displays login screen 300 on display portion 161 (step S01). It then accepts authentication information (step S02). The authentication information includes user identification information and a password. Next, it determines whether login button 305 has been designated (step S03). If so, the process proceeds to step S04; otherwise, the process returns to step S02. In step S04, the number of detected positions in a determination area is counted. The determination area is the area corresponding to login button 305 in login screen 300. The detected position is the position that is designated with a finger or a stylus pen and detected by touch panel 165. Specifically, of the coordinates of the positions output from touch panel 165, the number of the positions included in the area of login button 305 is counted. It is then determined whether the counted value is not greater than a threshold value T (step S05). If the counted value is equal to or smaller than threshold value T, the process proceeds to step S06; whereas if the counted value exceeds threshold value T, the process proceeds to step S11. Threshold value T may be set to the total number of positions on touch panel 165 that may be detected by touch panel 165 when it is touched with a human finger. The human fingers vary in size among individuals. Thus, the threshold value may be set to the value that is greater than the total number of the positions that may be detected by touch panel 165 when it is touched with a stylus pen. The process proceeds to step S06 if touch panel 165 is touched with a stylus pen. In this case, the operation system is determined to be the first operation system. In the following step S07, first operation system screen 73 stored in HDD 116 is read for display on display portion 161. It is then determined whether an operation has been accepted (step S08). Here, the operation is accepted via the first operation system determined in step S06. The process specified by the accepted operation is executed (step S09), and the process proceeds to step S10. In step S10, it is determined whether a logout instruction has been accepted. If the logout instruction is accepted, the process is terminated; otherwise, the process returns to step S07. That is, the operations are accepted via the first operation system from when the authenticated user logs in until the user logs out.

The process proceeds to step S11 if touch panel 165 is touched with a finger. In this case, the operation system is determined to be the second operation system. In the following step S12, second operation system screen 75 stored in HDD 116 is read for display on display portion 161. It is then determined whether an operation has been accepted (step S13). Here, the operation is accepted via the second operation system determined in step S11. The process specified by the accepted operation is executed (step S14) before the process proceeds to step S15. In step S15, it is determined whether a logout instruction has been accepted. If so, the process is terminated; otherwise, the process returns to step S12. That is, the operations are accepted via the second operation system from when the authenticated user logs in until the user logs out.

As described above, according to the present embodiment, MFP 100 discriminates operating objects, between a stylus pen and a human finger, based on the number of positions simultaneously detected by touch panel 165 on the operation-accepting surface thereof, and determines one of the first and second operation systems based on the result of discrimination. It then accepts an operation, according to the determined one of the first and second operation systems, based on the position detected by the touch panel. Accordingly, the operation can be input via the operation system suited to the operating object, which facilitates an operation.

Further, in the case where the number of positions detected by touch panel 165 is not greater than a threshold value T, it is determined that the operating object is a stylus pen; whereas if the number of positions detected exceeds threshold value T, it is determined that the operating object is a human finger. As such, the operating objects can easily be discriminated. While MFP 100 has been described as an example of the input apparatus in the above embodiment, the present invention may of course be understood as an operation accepting method for performing the processing shown in FIG. 8, or an operation accepting program for causing a computer to execute the operation accepting method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An input apparatus comprising:
a pointing device having an operation-accepting surface and detecting a position on the operation-accepting surface designated by a user;
an operating object discriminating portion to discriminate types of operating objects based on the number of positions on said operation-accepting surface simultaneously detected by said pointing device;
an operation system determining portion to determine one of a plurality of predetermined operation systems based on said discriminated type of the operating object; and
an operation accepting portion to accept an operation in accordance with said determined one of said plurality of operation systems based on the position detected by said pointing device.

2. The input apparatus according to claim 1, wherein said operating object discriminating portion discriminates the operating object of a first type in the case where the number of positions detected by said pointing device is not greater than a predetermined number, and said operating object discriminating portion discriminates the operating object of a second type in the case where the number of positions detected by said pointing device is greater than said predetermined number.

3. The input apparatus according to claim 1, wherein said plurality of operation systems includes a first operation system in which an operation is specified with a plurality of positions detected by said pointing device and a second operation system in which an operation is specified with a single position detected by said pointing device.

4. The input apparatus according to claim 1, further comprising a screen display portion capable of displaying an image on said operation-accepting surface of said pointing device in a superimposed manner, wherein
said screen display portion displays one of a plurality of types of operation screens corresponding to said determined operation system.

5. An operation accepting method carried out in an input apparatus having a pointing device, comprising the steps of:
detecting a position on an operation-accepting surface of said pointing device designated by a user;
discriminating types of operating objects based on the number of positions simultaneously detected in said detecting step;
determining one of a plurality of predetermined operation systems based on said discriminated type of the operating object; and
accepting an operation in accordance with said determined one of said plurality of operation systems based on the position detected in said detecting step.

6. The operation accepting method according to claim 5, wherein said step of discriminating the types of the operating objects includes the step of discriminating the operating object of a first type in the case where the number of positions detected in said detecting step is not greater than a predetermined number and discriminating the operating object of a second type in the case where the number of positions detected in said detecting step is greater than said predetermined number.

7. The operation accepting method according to claim 5, wherein said plurality of operation systems includes a first operation system in which an operation is specified with a plurality of positions detected in said detecting step and a second operation system in which an operation is specified with a single position detected in said detecting step.

8. The operation accepting method according to claim 5, wherein said input apparatus further includes a screen display portion capable of displaying an image on said operation-accepting surface of said pointing device in a superimposed manner,
the method further comprising the step of displaying one of a plurality of types of operation screens corresponding to said determined operation system on said screen display portion.

9. An operation accepting program embodied on a computer readable medium, the program being executed by a computer having a pointing device, the program causing the computer to perform the steps of:
detecting a position on an operation-accepting surface of said pointing device designated by a user;
discriminating types of operating objects based on the number of positions simultaneously detected in said detecting step;
determining one of a plurality of predetermined operation systems based on said discriminated type of the operating object; and
accepting an operation in accordance with said determined one of said plurality of operation systems based on the position detected in said detecting step.

10. The operation accepting program according to claim 9, wherein said step of discriminating the types of the operating objects includes the step of discriminating the operating object of a first type in the case where the number of positions detected in said detecting step is not greater than a predetermined number and discriminating the operating object of a second type in the case where the number of positions detected in said detecting step is greater than said predetermined number.

11. The operation accepting program according to claim 9, wherein said plurality of operation systems includes a first operation system in which an operation is specified with a plurality of positions detected in said detecting step and a second operation system in which an operation is specified with a single position detected in said detecting step.

12. The operation accepting program according to claim 9, wherein said computer further includes a screen display portion capable of displaying an image on said operation-accepting surface of said pointing device in a superimposed manner,
the program causing the computer to further perform the step of displaying one of a plurality of types of operation screens corresponding to said determined operation system on said screen display portion.
